(19) United States
(12) Patent Application Publication
(10) Pub. No.: US 2021/0117835 A1
(43) Pub. Date: Apr. 22, 2021

(54) SYSTEM AND METHOD FOR ENHANCING STRATEGIC PATROL PLANNING AND DISPATCH DECISION MAKING BASED ON GONE ON ARRIVAL PREDICTION

(71) Applicant: MOTOROLA SOLUTIONS, INC., CHICAGO, IL (US)

(72) Inventors: MARIYA BONDAREVA, BOLINGBROOK, IL (US); DAVID KALEKO, OAK PARK, IL (US); JEHAN WICKRAMASURIYA, SAINT CHARLES, IL (US)

(21) Appl. No.: 16/654,277

(22) Filed: Oct. 16, 2019

(51) Int. Cl. G06N 7/00; G06Q 50/26

(52) U.S. Cl. CPC G06N 7/005; G06Q 50/265

(57) ABSTRACT

Techniques for enhancing strategic patrol planning and dispatch decision making based on gone on arrival prediction are provided. In one aspect, a crime prediction map may be retrieved. The crime prediction map may include incident locations and incident times, of predicted incidents occurring within a geographic area. The predictions may be based on historical data, the historical data including data from a computer aided dispatch (CAD) system. For each predicted incident location and incident time, a probability of gone on arrival (GOA) incident disposition may be calculated for a plurality of responder response times. The probability may be calculated based on the historical data from the CAD system.

### BACKGROUND

Predictive policing generally refers to the use of analytic techniques to identify potential criminal activity. In one example case, large amounts of historical crime data (e.g. incident data) may be analyzed in an attempt to predict locations that have a higher probability of being the site of criminal activity in the future. For example, crime prediction maps may be created that display the expected number of incidents in a given area for each hour of the day. Based on historical patterns, a certain area of a city may be expected to have very few incidents during the early morning hours, but many incidents during the late evening hours. The incidents may even be further broken down by incident types. For example, in the morning, a certain area may be expected to have mostly traffic incidents, while in the evening that same area may be expected to have fewer traffic incidents, but more assault incidents.

These crime prediction maps may then be used for both strategic and tactical decision making. For example, when planning police patrol routes, the crime prediction maps may be used to define routes that place police officers closer to areas that are expected to have greater numbers of more serious incidents and further away from areas that are expected to have fewer or less serious incidents. The predictive crime maps may also be used to inform dispatch decisions. When multiple calls for service (CFS) are received at a public safety answering point (PSAP) (e.g. 911 call center), and there are not sufficient police resources available to concurrently handle all CFS, dispatchers must make prioritization decisions to determine which CFS are responded to immediately. Assuming two incidents of equal severity, but different location, are being reported, with only one officer available to be dispatched, the crime prediction map may guide the dispatcher to send the officer to the area where higher numbers of incidents are expected to occur. By making such a decision, the officer may be better positioned to respond to the next CFS.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a high level example of a crime prediction map that includes calculated probabilities for gone on arrival incident disposition.

FIG. 2 is an example of utilizing a crime prediction map including gone on arrival probabilities for planning patrol routes.

FIG. 3 is an example of utilizing a crime prediction map including gone on arrival probabilities for making dispatch decisions.

FIG. 4 is an example flow diagram for generating and using a crime prediction map including gone on arrival probabilities for making patrol and dispatch decisions.

FIG. 5 is an example of a GOA probability computation device that may implement the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Crime prediction maps may be good at determining the probability of when and where crimes may occur based on historical data. A problem arises in that planning patrol routing and making dispatch decisions using crime prediction maps that don't take into account the disposition of those historical incidents can result in ineffective law enforcement. For example, consider a hypothetical town with a bar at the east and west ends of town. Assume both bars have an equivalent history of drunken fights being reported. On a crime prediction map, both bars may appear identical from a crime prediction perspective. When planning a patrol route, it may seem logical to plan the patrol route such that an officer remains roughly in the middle of the town, so that responding to a fight at either bar would result in roughly the same response time. In the case where a CFS for each bar is received at the same time, and the officer happens to be closer to one bar than the other, it may seem to make more sense to dispatch the officer to the closer bar.

Upon arrival at an incident scene, it is possible that a suspect in the incident is no longer at the scene. Witnesses to the incident may still be on the scene, but the opportunity to apprehend the suspect is no longer available. These incidents may result in a disposition of “Gone on Arrival” (GOA), meaning that upon the officer's arrival there was no suspect to apprehend. In a subset of GOA cases, upon the officer's arrival, not only has the suspect left the scene, there are also no witnesses remaining at the scene. Such cases may be referred to as “Unfounded” because the officer would be able to provide no evidence (other than the 911 call) that an incident occurred at all. For ease of description, the remainder of this description will refer to both GOA and Unfounded incident dispositions as GOA. However, it should be understood that both cases are contemplated.

Returning to the hypothetical town example, assume that the bar at the east end of the town is a professional operation with a full security staff. Upon the occurrence of a fight (e.g. incident) the security staff detains any and all fighters until law enforcement arrives. Thus, it would be expected that the incidents at the east end bar rarely result in a GOA disposition. On the other hand, assume that the bar on the west end employs a single bouncer whose sole instruction when a fight occurs is to eject the fight instigator (e.g. suspect) from the bar to prevent damage to the interior of the establishment. There is a likelihood that the suspect would leave the incident location prior to officer arrival. That likelihood increases the longer the response time of the officer.

As should be clear, in the hypothetical town described above, planning patrol routes and making dispatch decisions based solely on historical incidents, without taking into account the dispositions of those incidents, could potentially result in lower apprehension rates. In the case of patrol routing, keeping an officer near the center of town to ensure roughly equivalent response times to each bar may come at the expense of increases in GOA dispositions when responding to incidents at the bar at the west end of town. Likewise, consider the case when an incident occurs at both bars at the same time. Assume there is only one officer available and he is closer to the east end of town. Dispatching the officer to the east end bar first, where there is a minimal chance of a GOA, increases the likelihood that when the officer eventually arrives at the west end bar, he will encounter a GOA disposition.

The techniques described herein solve these problems and others, individually and collectively. Using historical incident disposition data, the probability of GOA incident disposition is calculated for a number of different response times. Crime prediction maps may then be updated to include these probabilities. The GOA probabilities can then be used as additional inputs to the routing algorithms that are used to define patrol routes. In addition, the GOA probabilities may be used by systems that make dispatch recommendations in order to reduce the number of GOA incident dispositions.

A method is provided. The method may include retrieving a crime prediction map, the crime prediction map including incident locations and incident times, of predicted incidents occurring within a geographic area, the predictions based on historical data, the historical data including data from a computer aided dispatch (CAD) system. The method may further include calculating a probability of gone on arrival (GOA) incident disposition for a plurality of responder response times, the probability calculated based on the historical data from the CAD system, for each predicted incident location and incident time.

In one aspect, the method may further comprise generating a law enforcement patrol schedule based on the crime prediction map and the calculated probability of GOA incident disposition. In one aspect, the crime prediction map may further include a plurality of predicted incident types and calculating the probability of GOA incident disposition further comprises calculating the probability of GOA incident disposition for the plurality of response times for each predicted incident type. In one aspect, the crime prediction map may further include a plurality of predicted incident severity levels and calculating the probability of GOA incident disposition further comprises calculating the probability of GOA incident disposition for the plurality of response times for each predicted severity level.

In one aspect, generating the law enforcement patrol schedules may further comprise generating the law enforcement patrol schedules to decrease response times for locations with higher probability for GOA incident disposition. In one aspect, generating the law enforcement patrol schedules may further comprise generating the law enforcement patrol schedules to increase response times for locations with lower probability for the GOA incident disposition.

A system is provided. The system may include a processor and a memory coupled to the processor. The memory may contain a set of instructions thereon that when executed by the processor cause the processor to retrieve a crime prediction map, the crime prediction map including incident locations and incident times, of predicted incidents occurring within a geographic area, the predictions based on historical data, the historical data including data from a computer aided dispatch (CAD) system. The instructions may further cause the processor to calculate a probability of gone on arrival (GOA) incident disposition for a plurality of responder response times, the probability calculated based on the historical data from the CAD system, for each predicted incident location and incident time.

In one aspect, the system may further comprise instructions to generate a law enforcement patrol schedule based on the crime prediction map and the calculated probability of GOA incident disposition. In one aspect, the crime prediction map may further include a plurality of predicted incident types and calculating the probability of GOA incident disposition may further comprise instructions to calculate the probability of GOA incident disposition for the plurality of response times for each predicted incident type. In one aspect, the crime prediction map may further include a plurality of predicted incident severity levels and calculating the probability of GOA incident disposition may further comprise instructions to calculate the probability of GOA incident disposition for the plurality of response times for each predicted severity level.

In one aspect, the instructions to generate the law enforcement patrol schedules may further comprise instructions to generate the law enforcement patrol schedules to decrease response times for locations with higher probability for GOA incident disposition. In one aspect, the instructions to generate the law enforcement patrol schedules may further comprise instructions to generate the law enforcement patrol schedules to increase response times for locations with lower probability for the GOA incident disposition.

A non-transitory processor readable medium containing a set of instructions thereon is provided. The instructions, that when executed by a processor may cause the processor to retrieve a crime prediction map, the crime prediction map including incident locations and incident times, of predicted incidents occurring within a geographic area, the predictions based on historical data, the historical data including data from a computer aided dispatch (CAD) system. The instructions may further cause the processor to calculate a probability of gone on arrival (GOA) incident disposition for a plurality of responder response times, the probability calculated based on the historical data from the CAD system, for each predicted incident location and incident time.

In one aspect, the medium may further comprise instructions that cause the processor to generate a law enforcement patrol schedule based on the crime prediction map and the calculated probability of GOA incident disposition. In one aspect, the crime prediction map may further include a plurality of predicted incident types and calculating the probability of GOA incident disposition may further comprise instructions to calculate the probability of GOA incident disposition for the plurality of response times for each predicted incident type. In one aspect, the crime prediction map may further include a plurality of predicted incident severity levels and calculating the probability of GOA incident disposition may further comprise instructions to calculate the probability of GOA incident disposition for the plurality of response times for each predicted severity level.

In one aspect, the instructions to generate the law enforcement patrol schedules may further comprise instructions to generate the law enforcement patrol schedules to decrease response times for locations with higher probability for GOA incident disposition. In one aspect, the instructions to generate the law enforcement patrol schedules may further comprise instructions to generate the law enforcement patrol schedules to increase response times for locations with lower probability for the GOA incident disposition.

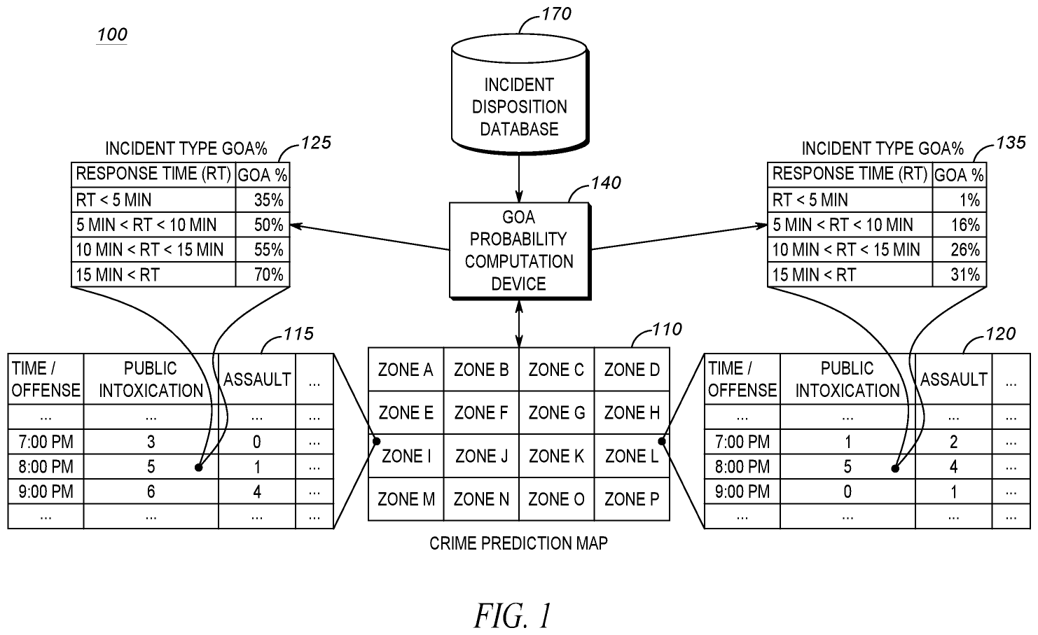

FIG. 1 is a high level example of a crime prediction map that includes calculated probabilities for gone on arrival incident disposition. Environment 100 may include crime prediction map 110, GOA probability computation device 140, and incident disposition database 170.

Crime prediction map 110 may depict a geographic region covered by a law enforcement agency. In the present example, the geographic area is defined as a grid, with each grid element identified by a Zone identifier (A-P). It should be understood that the representation in FIG. 1 is simply an example, and other representations are possible. For example, the geographic area may be broken down by police precincts, neighborhoods, zip codes, etc. The use of a grid, as shown, is simply for ease of description. The specific criteria for defining a portion of a geographic zone is relatively unimportant.

Crime prediction maps may be created by analyzing historical incident data and based on that data, predicting when and where certain types of crimes may occur based on the analysis. For example, for each zone depicted in crime prediction map 110, a crime prediction map generator (not shown) may analyze historical incident data (not shown) to generate a prediction of the types and numbers of crimes that are to be expected within each portion of the geographic area. For example, consider crime prediction table 115, which depicts a portion of the crime prediction map for Zone I. Although only a portion of the table is shown (e.g. only 3 hours of the day, and only two possible crime types), if should be understood that an actual implementation may cover the entire day as well as many more types of crimes. The simplification of the crime prediction table is for purposes of ease of description only.

As shown, crime prediction table 115 depicts two possible types of crimes, Public Intoxication and Assault (Note: for purposes of simplicity of explanation, a fight at a bar will be referenced by public intoxication). For each of those types of crimes, the crime prediction table 115 shows the number of predicted occurrences for each hour of the day. For ease of description, only three hours of the day are shown. It should be understood that the specific form of the crime prediction table is unimportant. The table could be broken down using different time periods (e.g. every 30 minutes, standard police shifts, etc.). The types of crimes included could also be listed with greater or lesser degrees of specificity (e.g. listed by specific criminal statute violated, felony/misdemeanor, etc.). What should be understood is that the crime prediction table may include when, where, type, and how often crimes are predicted to occur. For purposes of further description, crime prediction table 120 shows the crime prediction table for Zone L of the crime prediction map 110.

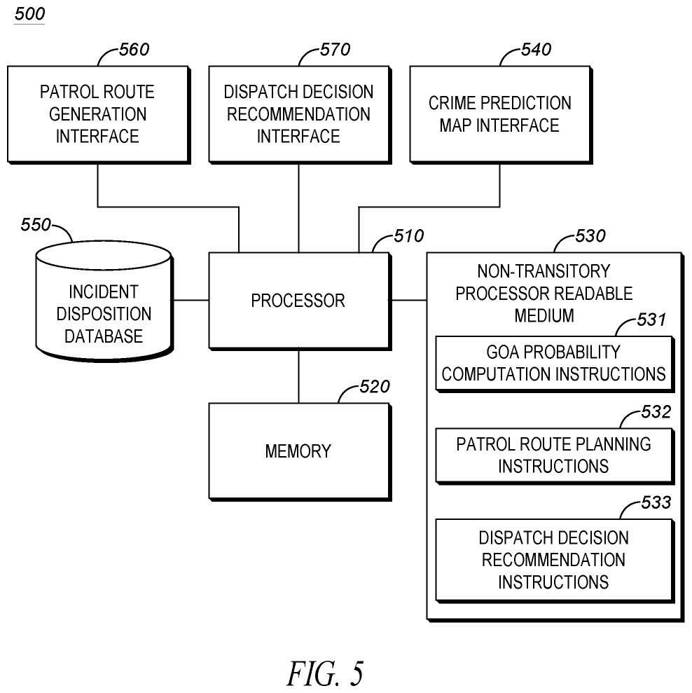

Environment 100 may also include a GOA probability computation device 140. An example of a specific structure that may implement a GOA probability computation device 140 is described with respect to FIG. 5. The GOA probability computation device 140 may be coupled to Incident Disposition Database 170. The Incident disposition database 170 may include dispositions of all incidents that occur within the geographic area identified by the crime prediction map 110. For purposes of ease of description, there will only be two incident dispositions described: 1. GOA (including Unfounded) and 2. Other (e.g. suspect apprehended, no action taken, etc.).

It should also be noted that although incident disposition database 170 is described as including only incident dispositions, the database may actually contain all incident related data, including the incident data that is used to generate the crime prediction map 110. What should be understood is that GOA probability computation device 140 has access to incident disposition data, regardless of if that data is stored in a separate database or in a database that includes other incident related data.

In operation in accordance with the present example, the GOA probability computation device 140 may compute, for each geographic zone, for each time period, and for each crime (incident) type, the probability that an incident will result in a GOA disposition. For example, as shown in crime prediction table 115, in Zone I, during the 8:00 PM hour, there are predicted to be 5 public intoxication incidents based on historical incident data.

The GOA probability computation device 140 may retrieve the incident dispositions for all public intoxication incidents that occurred in Zone I during the 8:00 PM hour. For example, assume that there were a total of 1000 public intoxication incidents that occurred during the 8:00 PM hour in Zone I. Those incidents that resulted in a GOA disposition may be grouped based on a plurality of response times. For each of the plurality of response times, the GOA probability computation device 140 may utilize the incident depositions data to calculate the probability (e.g. percentage) of the times that a particular response time results in a GOA disposition.

For example, assume that of the 1000 public intoxication incidents that occurred in Zone I during the 8:00 PM hour, 700 resulted in a GOA disposition. As such, the expected probability of a GOA disposition overall may be 70% (700/1000). Of these 700, assume that the response time was less than 5 minutes for 350 incidents, between 5 and 10 minutes for 150 incidents, between 10 and 15 minutes for 50 incidents, and greater than 15 minutes for 150 incidents. Thus, the probability of a GOA disposition for a response time under 5 minutes would be 35% (350/1000). To compute the probability of a GOA disposition for a response time between 5 and 10 minutes, the cumulative probability of all responses under 10 minutes must be considered. In this case, there were a total of 500 GOA dispositions (350 where response time was less than 5 minutes plus 150 where response time was between 5 and 10 minutes). Thus the overall probability of a GOA disposition of a response time between 5 and 10 minutes is 50% ((350+150)/1000).

Continuing with the example, to compute the GOA probability for response time between 10 and 15 minutes, the number of GOA dispositions with that response time (50) is added to the total number of GOA dispositions that were less than 10 minutes (500). Thus, the total number of GOA dispositions would be 550 (500 from the previous calculation plus the 50 incidents with a response time between 10 and 15 minutes). The probability of a GOA dispositions when the response time is between 10 and 15 minutes is 55% ((50+500)/1000). The same process is used to compute the probability for a GOA disposition for response times greater than 15 minutes. In the present example, there were 150 incidents that resulted in a GOA disposition. This is then added to the total number of GOA dispositions that were less than 15 minutes (550). Thus, the total number of GOA dispositions would be 700 (550 from the previous calculation plus the 150 incidents with a response time greater than 15 minutes). The probability of a GOA dispositions when the response time is greater than 15 minutes is 70% ((150+550)/1000). These probabilities are shown in the incident type GOA % table 125 shown for public intoxication incidents occurring in the 8:00 PM hour in Zone I.

The incident type GOA % table 135 for public intoxication incidents occurring in the 8:00 PM hour in zone L shows that the GOA probability may be different. For example, assume that there were a total of 800 public intoxication incidents, and of those 248 resulted in a GOA disposition. For a response time of less than 5 minutes, there were 8 incidents that resulted in GOA disposition. For a response time between 5 and 10 minutes, there were 120 incidents that resulted in GOA disposition. For a response time between 10 and 15 minutes, there were 80 incidents that resulted in GOA disposition. Finally, for a response time greater than 15 minutes, there were 40 incidents that resulted in GOA disposition. Using the process described above, the GOA probabilities for each response time are 1% (8/800), 16% ((120+8)/800), 26% ((80+128)/800), and 31% ((40+208)/800). These values are reflected in table 135.

Although tables 125,135 have been depicted as showing 4 possible response times, it should be understood that this is for purposes of description only. The techniques described herein are not limited to any particular number of response times (e.g. greater/less than a specified time, response times broken down on 30 minute intervals, response times broken down on per minute intervals, etc.). What should be understood is that given a geographic zone (however defined), a crime type (however defined), a time period (however defined), and a response time (however defined) the probability of a GOA disposition may be computed. This information may then be used at a later period of time to make various strategic and tactical decisions.

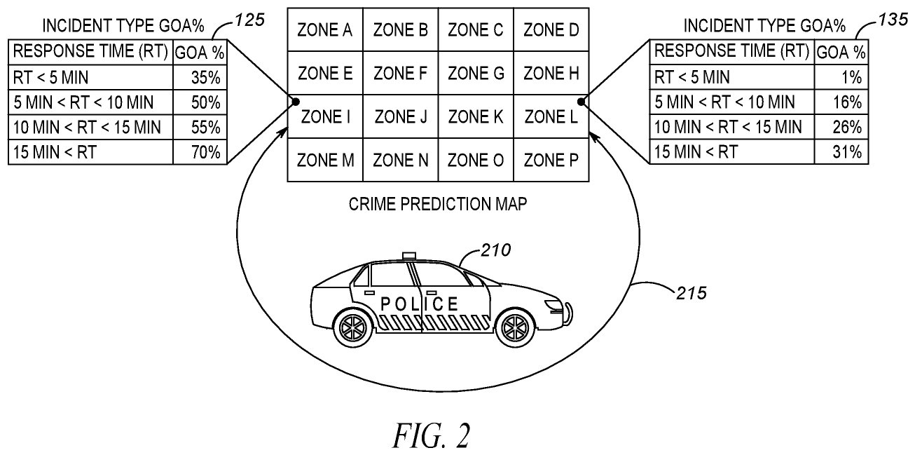

FIG. 2 is an example of utilizing a crime prediction map including gone on arrival probabilities for planning patrol routes. In other words, FIG. 2 is an example of using a crime prediction map including GOA probabilities for making strategic decisions. Although patrol route planning is one example of a strategic application of GOA probability prediction, the techniques described herein may be utilized with any form of strategic decision making.

The GOA probabilities are an addition to the crime prediction map that may be utilized as another input factor when planning patrol routes. There are known algorithms that utilize various inputs to plan routes. The addition of GOA probabilities is another factor that can be included in the planning of such routes. The techniques described herein are not intended to define new route planning algorithms, but are rather directed to a new input, GOA probability, that can be used in existing route planning algorithms.

FIG. 2 depicts the crime prediction map 110 shown in FIG. 1. For ease of description the crime prediction tables 115, 120, the GOA probability Computation Device 140, and the Incident Disposition Database 170 have been omitted. It should be understood that incident type GOA % tables 125, 135 are intended to depict the GOA % probability for a plurality of response times for a public intoxication incident during the 8:00 PM hour for a plurality of response times.

Assume that it takes approximately 10 minutes for an officer 210 to drive between Zone I and Zone L as depicted by arrow 215. For ease of explanation, assume that there is also only one officer qualified to respond to public intoxication incidents (e.g. only one officer on duty, only one trained to handle incident type, etc.). It should be understood that this assumption is being made for purposes of ease of description and not by way of limitation.

Based on crime prediction tables 115, 120, it can be seen that during the 8:00 PM hour, it is predicted that both Zone I and L are expected to have 5 public intoxication incidents, meaning that the likelihood of an incident occurring within either zone is the same. By looking at incident type GOA % tables 125 the likelihood of a suspect being GOA within the first 5 minutes in Zone I is 35% and by 10 minutes, there is a 50% chance of GOA. In Zone L the likelihood of a GOA is only 1% within 5 minutes, and 16% within 10 minutes.

If it takes 10 minutes to drive between Zone I and L, it should be clear that the officer should patrol Zone I. The reason being that if the officer patrols Zone L, and it takes 10 minutes to arrive at Zone I, there is a 50% chance that the suspect will be GOA. If the officer patrols zone I, there is a better likelihood that he will be able to respond to an incident within Zone I in under 5 minutes. Even if the officer has to drive 10 minutes to respond to an incident in Zone L, the GOA % according to table 135 would only be 16%, which is considerably less than the 50% probability of GOA when Zone L is patrolled and an incident occurs in Zone I. Thus, patrol routes can be based on trying to optimize the likelihood that an incident response does not result is a GOA disposition.

Furthermore, the above description has been based on a single incident type (e.g. public intoxication). It should be understood that there may be multiple incident types, and each of those types may have a severity level. When making patrol route planning decisions, incident severity may also be taken into consideration. For example, a homicide incident is more severe than a public intoxication incident. Designing a patrol route that has a 10% GOA probability for a public intoxication incident at the expense of a 75% GOA probability for a homicide incident would likely not be the most efficient use of resources. Patrol routing systems may also take into account the severity of the incidents in addition to the GOA percentages.

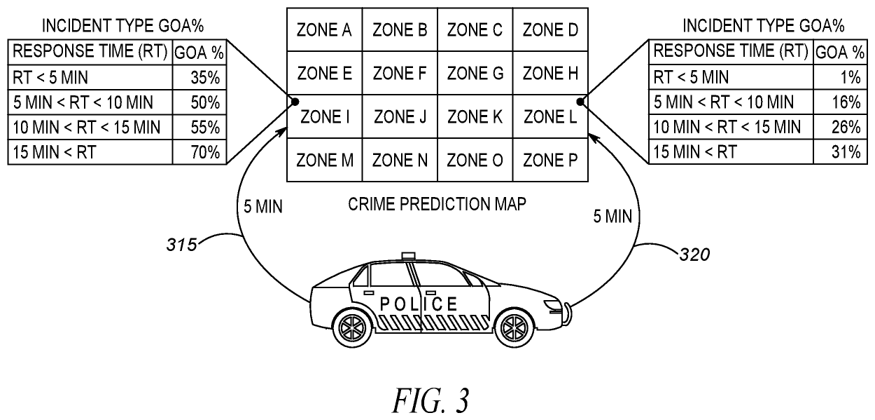

FIG. 3 is an example of utilizing a crime prediction map including gone on arrival probabilities for making dispatch decisions. In other words, FIG. 3 is an example of using a crime prediction map including GOA probabilities for making tactical decisions. Although dispatch decisions are one example of a tactical application of GOA probability prediction, the techniques described herein may be utilized with any form of tactical decision making.

The GOA probabilities are an addition to the crime prediction map that may be utilized as another input factor when making dispatch decisions. There are known algorithms that utilize various inputs to make recommendations for dispatch decisions. The addition of GOA probabilities is another factor that can be included in the recommendations. The techniques described herein are not intended to define new dispatch recommendation algorithms, but are rather directed to a new input, GOA probability, that can be used in existing dispatch recommendation algorithms.

FIG. 3 depicts the crime prediction map 110 shown in FIG. 1. For ease of description the crime prediction tables 115, 120, the GOA probability Computation Device 140, and the Incident Disposition Database 170 have been omitted. It should be understood that incident type GOA % tables 125, 135 are intended to depict the GOA % probability for a plurality of response times for a public intoxication incident during the 8:00 PM hour for a plurality of response times.

Assume a CFS for public intoxication comes in at the same time for both Zones I and L. Assume that an officer is approximately 5 minutes away from both Zone I and Zone L as depicted by arrows 315, 320. For ease of explanation, assume that there is also only one officer qualified to respond to public intoxication incidents (e.g. only one officer on duty, only one trained to handle incident type, etc.). It should be understood that this assumption is being made for purposes of ease of description and not by way of limitation.

By looking at incident type GOA % table 125 the likelihood of a suspect being GOA within 5 minutes in Zone I is 35%. In Zone L the likelihood of a GOA is only 1% within 5 minutes. Thus, it should be clear that the better dispatch recommendation would be to dispatch the officer to Zone L, because the likelihood of a GOA disposition is almost non-existent. Had the opposite decision been made, there would have been a 35% likelihood that the suspect would be GOA.

Just as above with respect to patrol route planning, it should be understood that there may be multiple incident types, and each of those types may have a severity level. When making dispatch recommendation decisions, incident severity may also be taken into consideration. For example, a homicide incident is more severe than a public intoxication incident. It may make more sense to dispatch an officer to a homicide incident with a 50% GOA probability instead of a public intoxication incident with a 1% GOA probability because the homicide incident is more severe than the public intoxication incident. Dispatch decision recommendation algorithms may also take into account the severity of the incidents in addition to the GOA percentages.

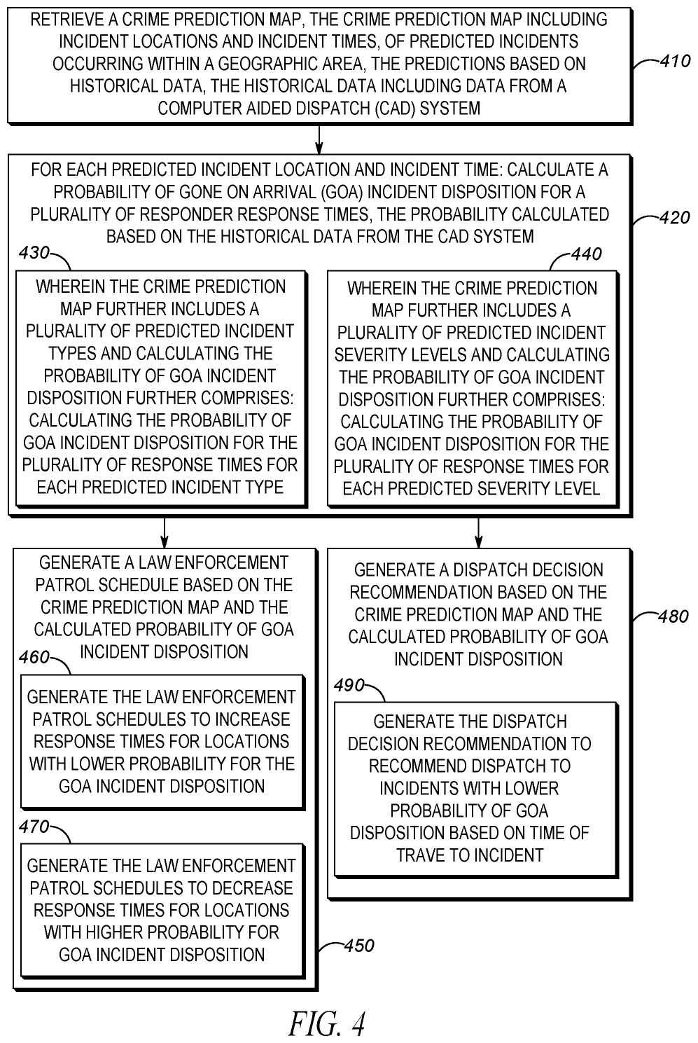

FIG. 4 is an example flow diagram for generating and using a crime prediction map including gone on arrival probabilities for making patrol and dispatch decisions. In block 410 a crime prediction map may be retrieved. The crime prediction map may include incident locations and incident times, of predicted incidents occurring within a geographic area. The predictions may be based on historical data, the historical data including data from a computer aided dispatch (CAD) system. In other words, a crime prediction map may be retrieved which indicates the likelihood that a crime will occur in a given location at a given time, based on historical occurrences of crime at the given place at the given time.

In block 420, for each predicted incident location and incident time, the probability of gone on arrival (GOA) incident disposition for a plurality of responder response times may be calculated. The probability may be calculated based on the historical data from the CAD system. In other words, for each incident location and time, historical data may be used to calculate the probability of a GOA disposition depending on how long it takes an officer to respond to the incident. As expected, the longer the time to respond, the greater the likelihood of a GOA disposition.

In block 430, wherein the crime prediction map further includes a plurality of predicted incident types, calculating the probability of GOA incident disposition may further comprise calculating the probability of GOA incident disposition for the plurality of response times for each predicted incident type. In other words, GOA probabilities may be calculated based on different incident types, and not just a generic incident.

In block 440, wherein the crime prediction map further includes a plurality of predicted incident severity levels, calculating the probability of GOA incident disposition may further comprise calculating the probability of GOA incident disposition for the plurality of response times for each predicted severity level. In other words, incidents may not only have a type, but different incidents may have different severity levels. The severity levels may be used later when making strategic and tactical decisions based on the GOA probabilities.

In block 450, a law enforcement patrol schedule may be generated based on the crime prediction map and the calculated probability of GOA incident disposition. As described above, GOA probability can be used to plan patrol routes in order to minimize the probability that an incident will result in a GOA disposition.

In block 460, the law enforcement patrol schedules may be generated to decrease response times for locations with higher probability for GOA incident disposition. This ensures that officers are closer to locations where it is predicted that too long a response time will result in higher probability of GOA. Conversely, in block 470, the law enforcement patrol schedules may be generated to increase response times for locations with lower probability for the GOA incident disposition. This ensures that officers are not patrolling locations with low probability of GOA at the expense of those areas with higher probabilities of GOA.

In block 480, dispatch decision recommendations may be generated based on the crime prediction map and the calculated probability of GOA incident disposition. As explained above, in some cases it may be desirable to dispatch an officer to one location over another, regardless of the response time of the officer. In block 490, the dispatch decision recommendation may be generated to recommend dispatch to incidents with lower probability of GOA disposition based on time of travel to the incident.

FIG. 5 is an example of a GOA probability computation device that may implement the techniques described herein. It should be understood that FIG. 5 represents one example implementation of a computing device that utilizes the techniques described herein. Although only a single processor is shown, it would be readily understood that a person of skill in the art would recognize that distributed implementations are also possible. For example, the various pieces of functionality described above (e.g. GOA probability calculation, etc.) could be implemented on multiple devices that are communicatively coupled. FIG. 5 is not intended to imply that all the functionality described above must be implemented on a single device.

Device 500 may include processor 510, memory 520, non-transitory processor readable medium 530, crime prediction map interface 540, incident disposition database 550, patrol route generation interface 560, and dispatch decision recommendation interface.

Processor 510 may be coupled to memory 520. Memory 520 may store a set of instructions that when executed by processor 510 cause processor 510 to implement the techniques described herein. Processor 510 may cause memory 520 to load a set of processor executable instructions from non-transitory processor readable medium 530. Non-transitory processor readable medium 530 may contain a set of instructions thereon that when executed by processor 510 cause the processor to implement the various techniques described herein.

For example, medium 530 may include GOA probability computation instructions 531. The GOA probability computation instructions may cause device 500 to implement the techniques described herein. For example, the instructions 531 may cause the processor to retrieve a crime prediction map by utilizing crime prediction map interface 540. The instructions 531 may also cause the processor to retrieve incident dispositions from the incident disposition database 550. The instructions 531 may cause the processor to compute GOA probabilities for the retrieved crime map and include those probabilities within the crime prediction map. The functionality provided by the instructions 531 is described throughout the specification, including places such as blocks 410-430 in FIG. 4.

Medium 530 may include patrol route planning instructions 532. The processor may use patrol route planning instructions 532 in conjunction with the crime prediction maps including GOA probability to generate patrol routes. For example, the processor may utilize patrol route planning interface 560 to communicate with systems that may be utilized to plan patrol routes. The functionality provided by the instructions 532 is described throughout the specification, including places such as blocks 450-470 in FIG. 4.

Medium 530 may include dispatch decision recommendation instructions 533. The processor may use dispatch decision recommendation instructions 533 in conjunction with the crime prediction maps including GOA probability to generate dispatch decision recommendations. For example, the processor may utilize dispatch decision recommendation interface 570 to communicate with systems that may be utilized to generate dispatch decision recommendation. The functionality provided by the instructions 533 is described throughout the specification, including places such as blocks 480-490 in FIG. 4.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc read only memory (CD-ROM), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (IC) with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
retrieving a crime prediction map, the crime prediction map including incident locations and incident times, of predicted incidents occurring within a geographic area, the predictions based on historical data, the historical data including data from a computer aided dispatch (CAD) system; and
for each predicted incident location and incident time:
calculating a probability of gone on arrival (GOA) incident disposition for a plurality of responder response times, the probability calculated based on the historical data from the CAD system.

2. The method of claim 1 further comprising:
generating a law enforcement patrol schedule based on the crime prediction map and the calculated probability of GOA incident disposition.

3. The method of claim 2 wherein the crime prediction map further includes a plurality of predicted incident types and calculating the probability of GOA incident disposition further comprises:
calculating the probability of GOA incident disposition for the plurality of response times for each predicted incident type.

4. The method of claim 3 wherein the crime prediction map further includes a plurality of predicted incident severity levels and calculating the probability of GOA incident disposition further comprises:
calculating the probability of GOA incident disposition for the plurality of response times for each predicted severity level.

5. The method of claim 3 wherein generating the law enforcement patrol schedules further comprises:
generating the law enforcement patrol schedules to decrease response times for locations with higher probability for GOA incident disposition.

6. The method of claim 3 wherein generating the law enforcement patrol schedules further comprises:
generating the law enforcement patrol schedules to increase response times for locations with lower probability for the GOA incident disposition.

7. A system comprising:
a processor; and
a memory coupled to the processor, the memory containing thereon a set of processor executable instructions that when executed cause the processor to:
retrieve a crime prediction map, the crime prediction map including incident locations and incident times, of predicted incidents occurring within a geographic area, the predictions based on historical data, the historical data including data from a computer aided dispatch (CAD) system; and
for each predicted incident location and incident time:
calculate a probability of gone on arrival (GOA) incident disposition for a plurality of responder response times, the probability calculated based on the historical data from the CAD system.

8. The system of claim 7 further comprising instructions to:
generate a law enforcement patrol schedule based on the crime prediction map and the calculated probability of GOA incident disposition.

9. The system of claim 8 wherein the crime prediction map further includes a plurality of predicted incident types and calculating the probability of GOA incident disposition further comprises instructions to:
calculate the probability of GOA incident disposition for the plurality of response times for each predicted incident type.

10. The system of claim 9 wherein the crime prediction map further includes a plurality of predicted incident severity levels and calculating the probability of GOA incident disposition further comprises instructions to:
calculate the probability of GOA incident disposition for the plurality of response times for each predicted severity level.

11. The system of claim 9 wherein the instructions to generate the law enforcement patrol schedules further comprises instructions to:
generate the law enforcement patrol schedules to decrease response times for locations with higher probability for GOA incident disposition.

12. The system of claim 9 wherein the instructions to generate the law enforcement patrol schedules further comprises instructions to:
generate the law enforcement patrol schedules to increase response times for locations with lower probability for the GOA incident disposition.

13. A non-transitory processor readable medium containing a set of instructions thereon that when executed by a processor cause the processor to:
retrieve a crime prediction map, the crime prediction map including incident locations and incident times, of predicted incidents occurring within a geographic area, the predictions based on historical data, the historical data including data from a computer aided dispatch (CAD) system; and
for each predicted incident location and incident time:
calculate a probability of gone on arrival (GOA) incident disposition for a plurality of responder response times, the probability calculated based on the historical data from the CAD system.

14. The medium of claim 13 further comprising instructions to:
generate a law enforcement patrol schedule based on the crime prediction map and the calculated probability of GOA incident disposition.

15. The medium of claim 14 wherein the crime prediction map further includes a plurality of predicted incident types and calculating the probability of GOA incident disposition further comprises instructions to:
calculate the probability of GOA incident disposition for the plurality of response times for each predicted incident type.

16. The medium of claim 15 wherein the crime prediction map further includes a plurality of predicted incident severity levels and calculating the probability of GOA incident disposition further comprises instructions to:
calculate the probability of GOA incident disposition for the plurality of response times for each predicted severity level.

17. The medium of claim 15 wherein the instructions to generate the law enforcement patrol schedules further comprises instructions to:
generate the law enforcement patrol schedules to decrease response times for locations with higher probability for GOA incident disposition.

18. The medium of claim 15 wherein the instructions to generate the law enforcement patrol schedules further comprises instructions to:
generate the law enforcement patrol schedules to increase response times for locations with lower probability for the GOA incident disposition.
